(19) United States
(12) Patent Application Publication
(10) Pub. No.: US 2004/0167259 A1
(43) Pub. Date: Aug. 26, 2004

(54) Method for producing aqueous copolymer dispersions of copolymers consisting of carbon monoxide and olefinically unsaturated compounds

(76) Inventors: Markus Schmid, Deidesheim (DE); Mubarik Mahmood Chowdhry, Straasbourg (FR); Marc Oliver Kristen, Limburgerhof (DE); Stefan Mecking, Freiburg (DE); Anke Held, Ludwigshafen (DE); Ekkehard Lindner, Tubingen (DE); Mahmoud Sunjuk, Tubingen (DE); Peter Wegner, Tubingen (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/482,402

(22) PCT Filed: Jul. 4, 2002
(86) PCT No.: PCT/EP02/07409

(30) Foreign Application Priority Data
Jul. 11, 2001 (DE) 10133042.1

(51) Int. Cl. C08L 1/00

(52) U.S. Cl. 524/318; 524/801; 524/804

(57) ABSTRACT

The invention relates to a method for producing aqueous copolymer dispersions of copolymers consisting of carbon monoxide and olefinically unsaturated compounds, by means of copolymerisation of carbon monoxide and olefinically unsaturated compounds in an aqueous medium in the presence of metallic complexes.

The present invention relates to a process for preparing aqueous dispersions of copolymers of carbon monoxide and olefinically unsaturated compounds, to the aqueous copolymer dispersions themselves and to their use.

Copolymers of carbon monoxide and olefinically unsaturated compounds, also referred to as carbon monoxide copolymers or polyketones for short, are known. For example, high molecular weight, partially crystalline polyketones having a strictly alternating sequence of the monomers in the main chain generally display high melting points, good heat distortion resistance, good chemical resistance, good barrier properties toward water and air and advantageous mechanical and rheological properties.

There is considerable industrial interest in polyketones derived from carbon monoxide and olefins, in general α-olefins, for example carbon monoxide-ethene, carbon monoxide-propene, carbon monoxide-ethene-propene, carbon monoxide-ethene-1-butene, carbon monoxide-ethene-1-hexene, carbon monoxide-propene-1-butene or carbon monoxide-propene-1-hexene copolymers.

Transition metal-catalyzed processes for preparing polyketones are known. For example, a cis-palladium complex chelated by bidentate phosphine ligands, [Pd(Ph₂P(CH₂)₃PPh₂)](OAc)₂ (Ph=phenyl, Ac=acetyl), is used in EP-A 0 121 965. The copolymerization of carbon monoxide can be carried out in suspension, as described in EP-A 0 305.011, or in the gas phase, for example as described in EP-A 0 702 045. Frequently used suspension media are low molecular weight alcohols, in particular methanol (cf. EP-A 0 428 228), and also nonpolar or polar aprotic liquids such as dichloromethane, toluene or tetrahydrofuran (cf. EP-A 0 460 743 and EP-A 0 590 942). Catalysts which have been found to be particularly useful for the above-mentioned copolymerization processes are, in particular, complexes containing bisphosphine chelating ligands which bear aryl or substituted aryl groups on the phosphorus. Accordingly, 1,3-bis(diphenylphosphino)propane or 1,3-bis[di(o-methoxyphenyl)phosphino)]propane are particularly frequently used as chelating ligands (cf. Drent et al., Chem. Rev., 1996, 96, pp. 663 to 681). In the cases mentioned, the copolymerization of carbon monoxide is usually carried out in the presence of acids.

The polymerization of carbon monoxide in low molecular weight alcohols such as methanol suffers from the disadvantage that the carbon monoxide copolymer being formed has a high uptake capacity for these liquids and up to 80% by volume of, for example, methanol can be bound or absorbed by the carbon monoxide copolymer. As a result, a high energy input is necessary to dry the carbon monoxide copolymers and isolate them in pure form. A further disadvantage is that residual amounts of alcohol always remain in the carbon monoxide copolymer even after intensive drying. Use as packaging material for foods is therefore ruled out for molding compositions produced in this way. EP-A 0 485 035 proposes the use of additions of from 2.5 to 15% by weight of water to the alcoholic suspension medium so as to eliminate the residual amounts of low molecular weight alcohol in the carbon monoxide copolymer. However, this procedure, too, does not lead to methanol-free copolymers. On the other hand, the use of halogenated hydrocarbons or aromatics such as dichloromethane or chlorobenzene or toluene brings problems in, in particular, handling and disposal.

To avoid the disadvantages associated with the suspension media mentioned, Jiang and Sen, Macromolecules, 1994, 27, pp. 7215 to 7216, describe the preparation of carbon monoxide copolymers in aqueous systems using a catalyst system comprising [Pd(CH₃CN)₄](BF₄)₂ and 1,3-bis[di(3-benzenesulfonic acid)phosphino]propane as water-soluble chelating ligand. However, the catalyst activity achieved is unsatisfactory.

Verspui et al., Chem. Commun., 1998, pp. 401 to 402, were able to increase the catalyst activity in the copolymerization of carbon monoxide and ethene above that achieved by Jiang and Sen by using the abovementioned chelating ligand in significantly purer form. Furthermore, the presence of a Bronsted acid is necessary to achieve the improved catalyst activities compared to those achieved by Jiang and Sen. The polyketones described in the publication, prepared from carbon monoxide and ethylene, have the disadvantage that their molecular weight is below that of comparable polyketones prepared in methanol as solvent.

In the abovementioned syntheses, the carbon monoxide copolymers formed (hereinafter referred to as “copolymers”) precipitate from the organic suspension media, are separated from the organic suspension media by filtration and are processed further as such. However, in many applications it is advantageous for the copolymers not to be present as such but in the form of aqueous copolymer dispersions. This is especially the case when the copolymers are to be used, for example, as binders in adhesives, sealing compositions, polymer-based plasters and renders or surface coatings.

The preparation of aqueous copolymer dispersions can in principle be carried out by appropriate suspension polymerization in organic solvents, filtration, drying, milling and dispersion of the milled copolymer particles in an aqueous medium (known as secondary dispersions). A disadvantage of this stepwise concept is that it is overall very complicated and the polymers are, especially because of the high solvent content, difficult to mill (conglutination in the mills), the copolymer particles obtained by milling can only be dispersed in an aqueous medium using large amounts of emulsifier (or cannot be dispersed at all) and these aqueous secondary dispersions are unstable because of their very broad particle size distribution and tend to form coagulum or sediment.

As regards the preparation of primary aqueous copolymer dispersions, i.e. aqueous copolymer dispersions which are obtainable directly by copolymerization of carbon monoxide and olefinically unsaturated compounds in an aqueous medium, the following prior art has been disclosed.

In an application filed by the Applicant at the German Patent and Trademarks Office under the application number 10061877, stable aqueous copolymer dispersions are obtained when the copolymerisation of carbon monoxide and olefinically unsaturated compounds is carried out in an aqueous medium using specific water-soluble metal catalysts and using specific comonomers.

An application likewise filed by the Applicant at the German Patent and Trademarks Office under the application number 10125238 discloses stable aqueous copolymer dispersions which are prepared by copolymerization of carbon monoxide and olefinically unsaturated compounds in an aqueous medium using the water-soluble metal catalysts specified in the above-mentioned application and using specific comonomers in the presence of host compounds. Furthermore, the document discloses that stable copolymer dispersions are obtainable even without the use of specific comonomers. This is especially the case when the copolymerization of carbon monoxide and the olefinically unsaturated compounds is carried out in the presence of ethoxylated emulsifiers.

It is an object of the present invention to provide a process for preparing primary aqueous copolymer dispersions by copolymerizing of carbon monoxide and olefinically unsaturated compounds in an aqueous medium using the oil-soluble metal complexes customary in suspension copolymerization.

We have found that this object is achieved by a process for preparing aqueous dispersions of copolymers of carbon monoxide and olefinically unsaturated compounds, in which the copolymerization of carbon monoxide and olefinically unsaturated compounds is carried out in an aqueous medium in the presence of a1) metal complexes of the formula (I)

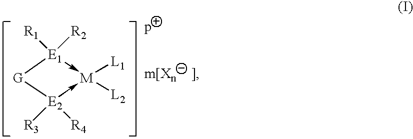

where the substituents and indices have the following meanings:

G is —(CR^{b}₂)ᵣ— or —(CR^{b}₂)ₛ—Si(R^{a})₂—(CR^{b}₂)ₜ—, -A-O—B— or -A-Z(R⁵)—B— where

R⁵ is hydrogen, linear or branched C₁-C₂₀-alkyl, C₃-C₁₀-cycloalkyl, C₆-C₁₄-aryl, C₆-C₁₄-aryl bearing functional groups based on nonmetallic elements of the groups IVA, VA, VIA and VIIA of the Periodic Table as substituents, aralkyl having from 1 to 20 carbon atoms in the alkyl part and from 6 to 14 carbon atoms in the aryl part, heteroaryl, long-chain radicals which have from 5 to 30 carbon atoms in the chain and have polar or charged end groups, —N(R^{b})₂, —Si(R^{c})₃ or a radical of the formula II

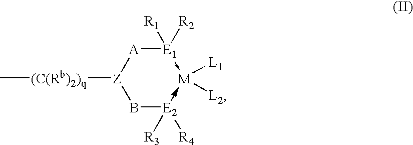

where

q is an integer from 0 to 20 and the further substituents in formula (II) are as defined for formula (I),

A, B are each —(CR^{b}₂)_{r′}— or —(CR^{b}₂)ₛ—Si(R^{a})₂—(CR^{b}₂)ₜ— or —N(R^{b})—, an r′-, s- or t-atomic constituent of a ring system or together with Z an (r′+1)-, (s+1)- or (t+1)-atomic constituent of a heterocycle,

R^{a} are each, independently of one another, linear or branched C₁-C₂₀-alkyl, C₃-C₁₀-cycloalkyl, C₆-C₁₄-aryl, C₆-C₁₄-aryl bearing functional groups based on nonmetallic elements of groups IVA, VA, VIA and VIIA of the Periodic Table as substituents, aralkyl having from 1 to 20 carbon atoms in the alkyl part and from 6 to 14 carbon atoms in the aryl part,

R^{b} may be as defined for R^{a} and may also be hydrogen or —Si (R^{c})₃,

R^{c} is linear or branched C₁-C₂₀-alkyl, C₃-C₁₀-cycloalkyl, C₆-C₁₄-aryl or aralkyl having from 1 to 20 carbon atoms in the alkyl part and from 6 to 14 carbon atoms in the aryl part,

r is 1, 2, 3 or 4 and

r′ is 1 or 2,

s, t are each 0, 1 or 2, where 1≦s+t≦3

z is an element of group VA of the Periodic Table of the Elements,

M is a metal selected from groups VIIIB, IB and IIB of the Periodic Table of the Elements,

E¹, E² are each a nonmetallic element of group VA of the Periodic Table of the Elements,

R¹ to R⁴ are each, independently of one another, linear or branched C₁-C₂₀-alkyl, C₃-C₁₀-cycloalkyl, C₆-C₁₄-aryl, C₆-C₁₄-aryl bearing functional groups based on nonmetallic elements of groups IVA, VA, VIA and VIIA of the Periodic Table as substituents, aralkyl having from 1 to 20 carbon atoms in the alkyl part and from 6 to 14 carbon atoms in the aryl part or heteroaryl,

L¹, L² are formally charged or uncharged ligands,

X are formally monovalent or polyvalent anions,

p is 0, 1, 2, 3 or 4,

m, n are each 0, 1, 2, 3 or 4,

where p=m×n,

or a compound of the formula (III)

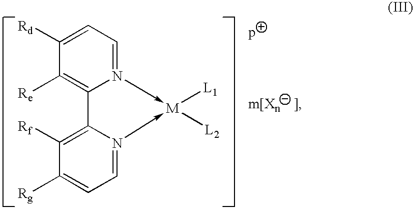

where

R^{d}, R^{e},

R^{f}, R^{g} are each, independently of one another, hydrogen, linear or branched C₁-C₆-alkyl or

R^{e} and R^{f} together form a five- or six-membered carbocycle or heterocycle and

the other substituents and indices are as defined under formula (I),

b) dispersants and, if desired

c) sparingly water-soluble organic solvents, where

d) the metal complexes a1) are present in solution in part of or the total amount of the olefinically unsaturated compounds and/or the sparingly water-soluble organic solvents c) and

e) the part or total amount of the olefinically unsaturated compounds and/or the sparingly water-soluble organic solvent c) in which the metal complexes a1) are dissolved is present in the aqueous medium as a disperse phase having a mean droplet diameter of ≦1000 nm.

In addition, the invention provides a process for preparing aqueous copolymer dispersions in which an acid a2) and, if desired, an organic hydroxy compound a3) is/are used in addition to the abovementioned components a1), b) and, if used, c).

Furthermore, the invention also provides the aqueous copolymer dispersions prepared by this process and provides for their use.

In the present text, the designations of the groups of the Periodic Table of the Elements are based on the nomenclature used by the Chemical Abstracts Service up to 1986 (thus, for example, group VA is made up of the elements N, P, As, Sb, Bi; group IB consists of Cu, Ag, Au).

Metals suitable as metals M in the metal complexes of the present invention are the metals of groups VIIIB, IB and IIB of the Periodic Table of the Elements, i.e., for example, copper, silver and zinc, also iron, cobalt and nickel and the platinum metals, viz. ruthenium, rhodium, osmium, iridium, platinum and very particularly preferably palladium.

Possible elements E¹ and E² in the chelating ligands are nonmetallic elements of main group V of the Periodic Table of the Elements, i.e., for example, nitrogen, phosphorus and arsenic. Particular preference is given to nitrogen or phosphorus, in particular phosphorus. The chelating ligands can contain different elements E¹ and E², for example nitrogen and phosphorus.

The structural unit G in the metal complex (I) is a monoatomic or polyatomic bridging structural unit. For the purposes of the present invention, a bridging structural unit is essentially a group which connects the elements E¹ and E² in structure (I) to one another.

Monoatomic bridging structural units are ones having one bridging atom from group IVA of the Periodic Table of the Elements, e.g. —C(R^{b})₂— or —Si(R^{a})₂—, where R^{a} are preferably each, independently of one another, linear or branched C₁-C₁₀-alkyl, for example methyl, ethyl, i-propyl or t-butyl, C₃-C₆-cycloalkyl such as cyclopropyl or cyclohexyl, C₆-C₁₀-aryl such as phenyl or naphthyl, C₆-C₁₀-aryl bearing functional groups based on nonmetallic elements of groups IVA, VA, VIA and VIIA of the Periodic Table as substituents, for example tolyl, (trifluoromethyl)phenyl, dimethylaminophenyl, p-methoxyphenyl or partially halogenated or perhalogenated phenyl, aralkyl having from 1 to 6 carbon atoms in the alkyl part and from 6 to 10 carbon atoms in the aryl part, for example benzyl, and R^{b} are preferably each, independently of one another, hydrogen or as defined above for R^{a}. R^{a} is particularly preferably a methyl group, and R^{b} is particularly preferably hydrogen.

Among polyatomically bridged systems, particular mention may be made of diatomically and triatomically bridged structural units, with the latter generally being preferred.

Examples of useful complexes containing diatomic bridging structural units include compounds of the formula (III)

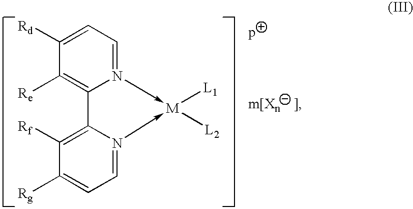

where

R^{d}, R^{e},

R^{f}, R^{g} are each, independently of one another, hydrogen, straight-chain or branched C₁-C₆-alkyl such as methyl, ethyl or i-propyl, or

R^{e} and R^{f} together form a five- or six-membered carbocycle or heterocycle and

the other substituents and indices have the general and preferred meanings given under formula (I).

Examples of chelating ligands containing diatomic bridging structural units are 1,10-phenanthroline, 2,2′-bipyridine and 4,4′-dimethyl-2,2′-bipyridine and their substituted derivatives.

Suitable triatomically bridged structural units are generally based on a chain of carbon atoms, i.e., for example, propylene (—CH₂CH₂CH₂—), or on a bridging unit containing a heteroatom from group IVA, VA or VIA of the Periodic Table of the Elements, e.g. silicon, nitrogen, phosphorus or oxygen, in the chain.

In the case of bridges built up entirely of carbon atoms, the free valences can be occupied by C₁-C₆-alkyl such as methyl, ethyl or t-butyl, C₆-C₁₀-aryl such as phenyl or by functional groups such as triorganosilyl, dialkylamino or halogen. Suitable substituted propylene bridges are, for example, those having a methyl, phenyl or methoxy group in the 2 position.

Among triatomically bridged structural units having a heteroatom in the chain, it is advantageous to use compounds in which Z is nitrogen (see above in the case of formula (I)). The radical R⁵ on Z can be, in particular: hydrogen, linear or branched C₁-C₁₀-alkyl such as methyl, ethyl, i-propyl or t-butyl, C₃-C₆-cycloalkyl such as cyclopropyl or cyclohexyl, C₆-C₁₀-aryl, for example phenyl, C₆-C₁₀-aryl bearing functional groups based on nonmetallic elements of groups IVA, VA, VIA and VIIA of the Periodic Table as substituents, e.g. tolyl, mesityl, aralkyl having from 1 to 6 carbon atoms in the alkyl part and from 6 to 10 carbon atoms in the aryl part, pyridyl, long-chain radicals which have from 12 to 22 carbon atoms in the chain and have polar or charged end groups, e.g. —SO₃—, —CO₂—, —CO₂R, —CONR₂, halogen, in particular —F, —Cl, —Br or —I, hydroxy, —OR, tosyl, —NR₂ or —NR₃⁺, —NH² (R is an aryl or alkyl radical or hydrogen), dialkylamino such as dimethylamino, dibenzylamino or diphenylamino, triorganosilyl such as trimethylsilyl, triphenylsilyl, triethylsilyl or t-butyldiphenylsilyl, or a radical of the formula (II)

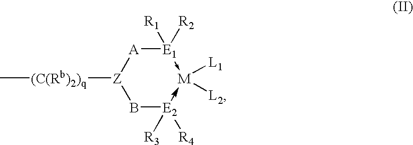

where the substituents and indices have the following meanings:

q is an integer from 1 to 20,

A, B are each —(CR^{b}₂)_{r′}— or —(CR^{b}₂)ₛ—Si(R^{a})₂—(CR^{b}₂)ₜ— or —N(R^{b})—, an r′-, s- or t-atomic constituent of a ring system or together with Z an (r′+1)-, (s+1)- or (t+1)-atomic constituent of a heterocycle,

R^{a} are each, independently of one another, hydrogen, linear or branched C₁-C₁₀-alkyl such as methyl, ethyl, i-propyl or t-butyl, C₃-C₆-cycloalkyl, for example cyclohexyl, C₆-C₁₀-aryl, for example phenyl, C₆-C₁₀-aryl bearing functional groups based on nonmetallic elements of groups IVA, VA, VIA and VIIA of the Periodic Table as substituents, e.g. tolyl, trifluoromethylphenyl, aminophenyl, hydroxyphenyl, anisyl or monochlorophenyl or dichlorophenyl, aralkyl having from 1 to 6 carbon atoms in the alkyl part and from 6 to 10 carbon atoms in the aryl part, for example benzyl,

R^{b} may be as defined for R^{a} and may also be hydrogen or —Si(R^{c})₃,

R^{c} is linear or branched C₁-C₁₀-alkyl such as methyl or ethyl, C₃-C₆-cycloalkyl, for example cyclohexyl, C₆-C₁₀-aryl, for example phenyl, or aralkyl having from 1 to 6 carbon atoms in the alkyl part and from 6 to 10 carbon atoms in the aryl part, for example benzyl, so that, for example, trimethylsilyl, triethylsilyl, triphenylsilyl or t-butyldiphenylsilyl are included under the formula —Si(R^{c})₃,

and the other substituents and indices are as defined under formula (I).

Among the metal complexes (I) chelated with monoatomically bridged ligands, preference is given, for example, to those in which M is doubly positively charged palladium, the elements E¹ and E² are phosphorus and the bridging structural unit G is methylene, ethylidene, 2-propylidene, dimethylsilylene or diphenylsilylene, in particular methylene. The monoatomically bridged metal complexes advantageously bear radicals R¹ to R⁴ of which at least one is a nonaromatic radical. Among aromatic radicals, particular mention may be made of phenyl and tolyl and also o-, m- or p-anisyl, while among the aliphatic radicals, particular mention may be made of methyl, ethyl, n- or i-propyl, n-, i- or t-butyl, n-, i- or neo-pentyl, -hexyl, -heptyl, -octyl, -nonyl, -decyl, -undecyl, -dodecyl, -tridecyl and -tetradecyl.

Particular preference is given to metal complexes (I) which have a triatomic bridge. These include, for example, compounds in which the elements E¹ and E² are joined by a propylene unit (—CH₂CH₂CH₂—) and the further substituents in formula (I) have the following meanings:

M is palladium or nickel, in particular palladium,

E¹, E² are each phosphorus or nitrogen, in particular phosphorus,

R¹ to R⁴ are each, independently of one another, linear or branched C₁-C₂₀-alkyl, frequently C₁-C₁₀-alkyl and often C₁-C₅-alkyl, for example methyl, ethyl, n- or i-propyl, n-, i- or t-butyl, n-, i- or neo-pentyl, -hexyl, -heptyl, -octyl, -nonyl, -decyl, -undecyl, -dodecyl, -tridecyl or -tetradecyl, substituted and unsubstituted C₃-C₆-cycloalkyl such as cyclopropyl, cyclohexyl or 1-methylcyclohexyl, in particular cyclohexyl, C₆-C₁₀-aryl such as phenyl or naphthyl, in particular phenyl, C₆-C₁₀-aryl bearing functional groups based on nonmetallic elements of groups IVA, VA, VIA and VIIA of the Periodic Table, e.g. linear or branched C₁-C₆-alkyl for example methyl, ethyl, i-propyl, t-butyl, partially halogenated or perhalogenated C₁-C₆-alkyl, for example trifluoromethyl or 2,2,2-trifluoroethyl, triorganosilyl such as trimethylsilyl, triethylsilyl or t-butyldiphenylsilyl, amino, for example dimethylamino, diethylamino or di-1-propylamino, alkoxy, for example methoxy, ethoxy or t-butoxy, or halogen such as fluorine, chlorine, bromine or iodine as substituents, aralkyl having from 1 to 3 carbon atoms in the alkyl radical and from 6 to 10 carbon atoms in the aryl radical, for example benzyl, or heteroaryl such as pyridyl,

L¹, L² are each acetonitrile, acetylacetone, trifluoroacetate, benzonitrile, tetrahydrofuran, diethyl ether, acetate, tosylate or water, or else methyl, ethyl, propyl, butyl, phenyl or benzyl,

X is tetrafluoroborate, hexafluorophosphate, hexafluoroantimonate, pentafluorobenzoate, trifluoromethanesulfonate, trifluoroacetate, perchlorate, p-toluenesulfonate or a tetraarylborate such as tetrakis(pentafluorophenyl)borate or tetrakis(3,5-bis(trifluoromethyl)phenyl)borate,

p is 0, 1, 2, 3 or 4,

m, n are each 0, 1, 2, 3 or 4,

where p=m×n.

Examples of preferred propylene-bridged metal complexes are

[1,3-bis(diphenylphosphino)propane]palladium(II) acetate, [1,3-bis(di(2-methoxyphenyl)phosphino)propane]palladium(ii) acetate,

[1,3-bis(dimethylphosphino)propane]palladium(II) acetate,

[1,3-bis(diethylphosphino)propane]palladium(II) acetate,

[1,3-bis(di(n-propyl)phosphino)propane]palladium(II) acetate,

[1,3-bis(di(isopropyl)phosphino)propane]palladium(II) acetate,

[1,3-bis(di(n-butyl)phosphino)propane]palladium(II) acetate,

[1,3-bis(di(n-pentyl)phosphino)propane]palladium(II) acetate,

[1,3-bis(di(n-hexyl)phosphino)propane]palladium(II) acetate,

[1,3-bis(di(isohexyl)phosphino)propane]palladium(II) acetate,

[1,3-bis(di(neohexyl)phosphino)propane]palladium(II) acetate,

[1,3-bis(di(n-heptyl)phosphino)propane]palladium(II) acetate,

[1,3-bis(di(3-(cyclopentyl)propyl)phosphino)propane]palladium(II) acetate,

[1,3-bis(di(n-octyl)phosphino)propane]palladium(II) acetate,

[1,3-bis(di(n-nonyl)phosphino)propane]palladium(II) acetate,

[1,3-bis(di(n-decyl)phosphino)propane]palladium(II) acetate,

[1,3-bis(di(n-dodecyl)phosphino)propane]palladium(II) acetate,

[1,3-bis(di(n-tetradecyl)phosphino)propane]palladium(II) acetate,

[1,3-bis(di(3-(cyclohexyl)propyl)phosphino)propane]palladium(II) acetate or

[1,3-bis(di(n-hexadecyl)phosphino)propane]palladium(II) acetate.

Among the triatomically bridged metal complexes (I), those having a bridging structural unit -A-N(R⁵)—B— are likewise preferred. The substituents and indices in these metal complexes (I) advantageously have the following meanings:

M is palladium or nickel, in particular palladium,

E¹, E² are each phosphorus or nitrogen, in particular phosphorus,

R¹ to R⁴ are each, independently of one another, linear or branched C₁-C₂₀-alkyl, frequently C₁-C₁₀-alkyl and often C₁-C₅-alkyl, for example methyl, ethyl, n- or i-propyl, n-, i- or t-butyl, n-, i- or neo-pentyl, -hexyl, -heptyl, -octyl, -nonyl, -decyl, -undecyl, -dodecyl, -tridecyl or -tetradecyl, substituted and unsubstituted C₃-C₆-cycloalkyl such as cyclopropyl, cyclohexyl or 1-methylcyclohexyl, in particular cyclohexyl, C₆-C₁₀-aryl such as phenyl or naphthyl, in particular phenyl, C₆-C₁₀-aryl bearing functional groups based on nonmetallic elements of groups IVA, VA, VIA and VIIA of the Periodic Table, e.g. linear or branched C₁-C₆-alkyl for example methyl, ethyl, i-propyl, t-butyl, partially halogenated or perhalogenated C₁-C₆-alkyl, for example trifluoromethyl or 2,2,2-trifluoroethyl, triorganosilyl such as trimethylsilyl, triethylsilyl or t-butyldiphenylsilyl, amino, for example dimethylamino, diethylamino or di-1-propylamino, alkoxy, for example methoxy, ethoxy or t-butoxy, or halogen such as fluorine, chlorine, bromine or iodine as substituents, aralkyl having from 1 to 3 carbon atoms in the alkyl part and from 6 to 10 carbon atoms in the aryl part, for example benzyl, or heteroaryl such as pyridyl,

L¹, L² are each acetonitrile, benzonitrile, acetone, acetylacetone, diethyl ether, tetrahydrofuran, acetate, trifluoroacetate, or benzene or else methyl, ethyl, propyl, butyl, phenyl or benzyl,

X is p-toluenesulfonate, methylsulfonate, trifluoromethanesulfonate, perchlorate, acetate, trifluoroacetate, tetrafluoroborate, tetraphenylborate, hexafluorophosphate, tetrakis(pentafluorophenyl)borate, tetrakis(3,5-bis(trifluoromethyl)phenyl)borate,

A, B are each —(CR^{b}₂)_{r′}— where r′ is 1 or 2, in particular 1, and R^{b} is defined as under formula II, in particular hydrogen, methyl or ethyl,

p is 0, 1, 2, 3 or 4,

m, n are each 0, 1, 2, 3 or 4,

where p=m×n.

Preferred radicals R⁵ correspond to those already mentioned above.

Examples are:

[N,N-bis(di(2-methoxyphenyl)phosphinomethyl)phenylamine]palladium (II) acetate,

[N,N-bis(diphenylphosphinomethyl)t-butylamine]palladium(II) acetate,

[N,N-bis(di(2-methoxy)phenylphosphinomethyl)t-butylamine]-palladium(II) acetate.

Further examples of particularly preferred metal complexes (I) are:

bis(acetonitrile)[N,N-bis(diphenylphosphinomethyl)phenylamine]-palladium(II) bis(tetrafluoroborate),

bis(acetonitrile)[N,N-bis(di(2-methoxyphenyl)phosphinomethyl)-phenylamine]palladium(II) bis(tetrafluoroborate),

bis(acetonitrile)[N,N-bis(diphenylphosphinomethyl)t-butylamine]-palladium(II) bis(tetrafluoroborate),

bis(acetonitrile)[N,N-bis(di(2-methoxy)phenylphosphinomethyl)t-butylamine]palladium(II) bis(tetrafluoroborate),

bis(acetonitrile)[1,3-bis(diphenylphosphino)propane]-palladium(II) bis(tetrafluoroborate),

bis(acetonitrile)[1,3-bis(di(2-methoxyphenyl)phosphino)propane]-palladium(II) bis(tetrafluoroborate),

bis(acetonitrile)[1,3-bis(dimethylphosphirio)propane]palladium(II) bis(tetrafluoroborate),

bis(acetonitrile)[1,3-bis(diethylphosphino)propane]palladium(II) bis(tetrafluoroborate),

bis(acetonitrile)[1,3-bis(di(n-propyl)phosphino)propane]-palladium(II) bis(tetrafluoroborate),

bis(acetonitrile)[1,3-bis(di(iso-propyl)phosphino)propane]-palladium(II) bis(tetrafluoroborate),

bis(acetonitrile)[1,3-bis(di(n-butyl)phosphino)propane]-palladium(II) bis(tetrafluoroborate),

bis(acetonitrile)[1,3-bis(di(n-pentyl)phosphino)propane]-palladium(II) bis(tetrafluoroborate),

bis(acetonitrile)[1,3-bis(di(n-hexyl)phosphino)propane]-palladium(II) bis(tetrafluoroborate),

bis(acetonitrile)[1,3-bis(di(isohexyl)phosphino)propane]palladium (II) bis(tetrafluoroborate),

bis(acetonitrile)[1,3-bis(di(neohexyl)phosphino)propane]palladium (II) bis(tetrafluoroborate),

bis(acetonitrile)[1,3-bis(di(n-heptyl)phosphino)propane]-palladium(II) bis(tetrafluoroborate),

bis(acetonitrile)[1,3-bis(di(3-(cyclopentyl)propyl)phosphino)-propane]palladium(II) bis(tetrafluoroborate),

bis(acetonitrile)[1,3-bis(di(n-octyl)phosphino)propane]-palladium(II) bis(tetrafluoroborate),

bis(acetonitrile)[1,3-bis(di(n-nonyl)phosphino)propane]palladium-(II) bis(tetrafluoroborate),

bis(acetonitrile)[1,3-bis(di(n-decyl)phosphino)propane]palladium-(II) bis(tetrafluoroborate),

bis(acetonitrile)[1,3-bis(di(n-dodecyl)phosphino)propane]-palladium(II) bis(tetrafluoroborate),

bis(acetonitrile)[1,3-bis(di(n-tetradecyl)phosphino)propane]-palladium(II) bis(tetrafluoroborate),

bis(acetonitrile)[1,3-bis(di(3-(cyclohexyl)propyl)phosphino)-propane]palladium(II) bis(tetrafluoroborate) or

bis(acetonitrile)[1,3-bis(di(n-hexadecyl)phosphino)propane]-palladium(II) bis(tetrafluoroborate) and the corresponding bis(perchlorates), bis(tetraphenylborates) and

bis(tetrakis(tris(2,4,6-trifluoromethyl)phenyl)borates) and also the corresponding complexes in which the bis(acetonitrile) unit is replaced by a bis(tetrahydrofuran) or bis(aqua) unit.

In a preferred embodiment, the abovementioned metal complexes a1) are used in the presence of acids a2), which are also referred to as activators.

As activator compounds, it is possible to use both mineral protic acids and Lewis acids. Suitable protic acids are, for example, sulfuric acid, nitric acid, boric acid, tetrafluoroboric acid, perchloric acid, p-toluenesulfonic acid, trifluoroacetic acid, trifluoromethanesulfonic acid or methanesulfonic acid. Preference is given to using p-toluenesulfonic acid and tetrafluoroboric acid. Possible Lewis acids are, for example, boron compounds such as triphenylborane, tris(pentafluorophenyl)borane, tris(p-chlorophenyl)borane or tris(3,5-bis(trifluoromethyl)phenyl)borane or aluminum, zinc, antimony or titanium compounds having Lewis acid character. It is also possible to use mixtures of protic acids or of Lewis acids or of protic acids and Lewis acids.

The molar ratio of any acid a2) used to metal complex a1), based on the amount of metal M, is generally in the range from 60:1 to 1:1, frequently from 25:1 to 2:1 and often from 12:1 to 3:1.

In a likewise preferred process, the abovementioned metal complexes a1) are used together with the acids a2) in the presence of organic hydroxy compounds a3).

Suitable organic hydroxy compounds a3) are all low molecular weight organic substances (M_{w}≦500) which have one or more hydroxyl groups. Preference is given to lower alcohols having from 1 to 6 carbon atoms, e.g. methanol, ethanol, n- or i-propanol, n-butanol, s-butanol or t-butanol. It is also possible to use aromatic hydroxy compounds such as phenol. Likewise suitable are, for example, sugars such as fructose, glucose or lactose. Polyalcohols such as ethylene glycol, glycerol or polyvinyl alcohol are also suitable. Of course, it is also possible to use mixtures of a plurality of hydroxy compounds a3).

The molar ratio of any hydroxy compound a3) used to metal complex a1), based on the amount of metal M, is generally in the range from 0 to 100000, often from 500 to 50000 and frequently from 1000 to 10000.

In general, the metals M in the complexes a1) can be present in formally uncharged form, formally singly positively charged form or preferably formally doubly positively charged form.

Suitable formally charged anionic ligands L¹, L² are hydride, sulfates, phosphates or nitrates. Further suitable ligands are carboxylates or salts of organic sulfonic acids such as methylsulfonate, trifluoromethylsulfonate or p-toluenesulfonate. Among the salts of organic sulfonic acids, p-toluenesulfonate is preferred. Preferred formally charged ligands L¹, L² are carboxylates, preferably C₁-C₂₀-carboxylates and in particular C₁-C₇-carboxylates, i.e. for example, acetate, trifluoroacetate, propionate, oxalate, citrate or benzoate. Particular preference is given to acetate.

Suitable formally charged organic ligands L¹, L² also include C₁-C₂₀-aliphatic radicals, C₃-C₁₄-cycloaliphatic radicals, C₇-C₂₀-arylalkyl radicals having from 6 to 14 carbon atoms in the aryl part and from 1 to 6 carbon atoms in the alkyl part and also C₆-C₁₄-aromatic radicals, for example methyl, ethyl, propyl, i-propyl, t-butyl, n-, i-pentyl, cyclohexyl, benzyl, phenyl and aliphatically or aromatically substituted phenyl radicals.

Suitable formally uncharged ligands L¹, L² are Lewis bases in general, i.e. compounds having at least one free electron pair. Particularly useful ligands of this type are Lewis bases whose free electron pair or pairs is/are located on a nitrogen or oxygen atom, i.e., for example, nitriles, R—CN, ketones, ethers, alcohols or water. Preference is given to using C₁-C₁₀-nitriles such as acetonitrile, propionitrile, benzonitrile, or C₂-C₁₀-ketones such as acetone, acetylacetone, or else C₂-C₁₀-ethers such as dimethyl ether, diethyl ether, tetrahydrofuran. Particular preference is given to using acetonitrile, tetrahydrofuran or water.

The ligands L¹ and L² can in principle be present in any ligand combination, i.e. the metal complexes (I) or (III) or the radical of the formula (II) can contain, for example, one nitrate radical and one acetate radical, one p-toluenesulfonate radical and one acetate radical or one nitrate radical and one formally charged organic ligand such as methyl. It is preferred that L¹ and L² in a given metal complex are identical.

Depending on the formal charge on the complex fragment containing the metal M, the metal complexes contain anions X. However, if the M-containing complex fragment is formally uncharged, the complex of formula (I) or (III) according to the present invention contains no anion X. It is advantageous to use anions X which have a very low nucleophilicity, i.e. have a very low tendency to undergo a strong interaction with the central metal M, whether ionic, coordinative or covalent.

Suitable anions X are, for example, perchlorate, sulfate, phosphate, nitrate and carboxylates such as acetate, trifluoroacetate, trichloroacetate, propionate, oxalate, citrate, benzoate, and also conjugate anions of organosulfonic acids, for example methylsulfonate, trifluoromethylsulfonate and p-toluenesulfonate, also tetrafluoroborate, tetraphenylborate, tetrakis(pentafluorophenyl)borate, tetrakis[bis(3,5-trifluoromethyl)phenyl]borate, hexafluorophosphate, hexafluoroarsenate or hexafluoroantimonate. Preference is given to using perchlorate, trifluoroacetate, sulfonates such as methylsulfonate, trifluoromethylsulfonate, p-toluenesulfonate, tetrafluoroborate or hexafluorophosphate, in particular trifluoromethylsulfonate, trifluoroacetate, perchlorate or p-toluenesulfonate.

Olefinically unsaturated compounds which can be used according to the present invention include both pure hydrocarbon compounds and heteroatom-containing α-olefins such as (meth)acrylic esters or (meth)acrylamides and also homoallyl or allyl alcohols, ethers or halides. Among pure hydrocarbons, C₂-C₂₀-1-alkenes are useful. Among these, particular mention may be made of the low molecular weight olefins, e.g. ethene or α-olefins having from 3 to 20 carbon atoms, e.g. propene, 1-butene, 1-pentene, 1-hexene, 1-heptene, 1-octene. Of course, it is also possible to use cyclic olefins such as cyclopentene, cyclohexene, norbornene, aromatic olefinic compounds such as styrene or α-methylstyrene or vinyl esters such as vinyl acetate. However, the C₂-C₂₀-1-alkenes are particularly suitable. Among these, special mention may be made of ethene, propene, 1-butene, 1-pentene, 1-hexene or 1-octene and also 1-decene, 1-dodecene, 1-tetradecene, 1-hexadecene and 1-octadecene as well as the olefin fractions from a cracker in which these are present. Of course, it is possible according to the present invention to use the abovementioned olefinically unsaturated compounds either individually or in admixture.

Furthermore, it is also possible to use the above-mentioned olefinically unsaturated compounds in admixture with compounds containing the structural element of the formula (IV)

—CH═CH-Q-Polₙ (IV).

In this formula, Q is a nonpolar organic group selected from the group consisting of linear or branched C₁-C₂₀-alkyl, often C₂-C₁₈-alkyl and frequently C₃-C₁₄-alkyl, for example methyl, ethyl, n- or i-propyl, n-, i- or t-butyl, n-, i- or neo-pentyl, -hexyl, -heptyl, -octyl, -nonyl, -decyl, -undecyl, -dodecyl, -tridecyl or -tetradecyl, C₃-C₁₄-cycloalkyl, for example cyclopropyl, cyclobutyl, cyclopentyl or cyclohexyl, C₆-C₁₄-aryl, for example phenyl, naphthyl or phenanthryl, and alkylaryl having from 1 to 20 carbon atoms in the alkyl part and from 6 to 14 carbon atoms in the aryl part, for example benzyl.

π polar groups Pol are bound to the nonpolar group Q. Here, π is a positive integer. π is preferably 1, 2, 3 or 4. Of course, π can also have a higher numerical value.

Pol is a polar radical selected from the group consisting of carboxyl (—CO₂H), sulfonyl (—SO₃H), sulfate (—OSO₃H), phosphonyl (—PO₃H), phosphate (—OPO₃H₂) and their alkali metal salts, in particular sodium or potassium salts, alkaline earth metal salts, for example magnesium or calcium salts, and ammonium salts.

Pol can likewise be an alkanolammonium, pyridinium, imidazolinium, oxazolinium, morpholinium, thiazolinium, quinolinium, isoquinolinium, tropylium, sulfonium, guanidinium or phosphonium compound or in particular an ammonium compound of the formula (V)

—N^{⊕}R⁶R⁷R⁸ (V),

obtainable by protonation or alkylation.

Here, R⁶, R⁷ and R⁸ are each, independently of one another, hydrogen or linear or branched C₁-C₂₀-alkyl, frequently C₁-C₁₀-alkyl and often C₁-C₅-alkyl, for example methyl, ethyl, n- or i-propyl, n-, i- or t-butyl, n-, i- or neo-pentyl, -hexyl, -heptyl, -octyl, -nonyl, -decyl, -undecyl, -dodecyl, -tridecyl or -tetradecyl. The corresponding anions of the above-mentioned compounds are nonnucleophilic anions such as perchlorate, sulfate, phosphate, nitrate and carboxylates such as acetate, trifluoroacetate, trichloroacetate, propionate, oxalate, citrate, benzoate, and conjugate anions of organosulfonic acids, for example methylsulfonate, trifluoromethylsulfonate and para-toluenesulfonate, also tetrafluoroborate., tetraphenylborate, tetrakis(pentafluorophenyl)borate, tetrakis[bis(3,5-trifluoromethyl)phenyl]borate, hexafluorophosphate, hexafluoroarsenate or hexafluoroantimonate.

The polar radical Pol can also be a group of the formula (VI), (VII) or (VIII)

-(EO)ₖ—(PO)ₗ—R⁹ (VI),

—(PO)ₗ-(EO)ₖ—R⁹ (VII),

-(EO)ₖ/POₗ)—R⁹ (VIII), where

EO is a —CH₂—CH₂—O— group,

PO is a —CH₂—CH(CH₃)—O— or a —CH(CH₃)—CH₂—O— group and k and 1 are numbers from 0 to 50, frequently from 0 to 30 and often from 0 to 15, but k and l are not both 0 at the same time.

Furthermore,

in formula (VI) and (VII): (EO)ₖ is a block of k —CH₂—CH₂—O— groups, and

(PO)ₗ is a block of l —CH₂—CH(CH₃)—O— or —CH(CH₃)—CH₂—O— groups, and

in formula (VIII): (EOₖ/POₗ) is a mixture of k —CH₂—CH₂—O— groups and

l is randomly distributed —CH₂—CH(CH₃)—O— or —CH(CH₃)—CH₂—O— groups.

R⁹ is hydrogen, linear or branched C₁-C₂₀-alkyl, often C₁-C₁₀-alkyl and frequently C₁-C₆-alkyl, or —SO₃H or its alkali metal, alkaline earth metal and/or ammonium salt. Here alkyl is, for example, methyl, ethyl, n- or i-propyl, n-, i- or t-butyl, n-, i- or neo-pentyl, -hexyl, -heptyl, -octyl, -nonyl, -decyl, -undecyl, -dodecyl, -tridecyl or -tetradecyl, alkali metal is, for example, sodium or potassium and alkaline earth metal is, for example, calcium or magnesium.

Compounds containing the structural element of the formula (IV) which are particularly preferably used according to the present invention are α-olefins of the formula (IX)

H₂C═CH—Q—Pol_{π} (IX),

where Q, Pol and π are as defined above.

Preferred olefins (IX) are 10-undecenoic acid, 3-butenoic acid, 4-pentenoic acid, 5-hexenoic acid and styrene-4-sulfonic acid.

The proportion of the olefinically unsaturated compound(s) containing the structural element of the formula (IV) in the monomer mixture to be polymerized, which consists of at least one olefinically unsaturated compound containing the structural element of the formula (IV) and at least one of the other olefinically unsaturated compounds mentioned above, is from 0 to 100% by weight, frequently from 0.5 to 80% by weight and often from 1.0 to 60% by weight or from 2.0 to 40% by weight.

As olefinically unsaturated compounds, particular preference is given according to the present invention to using ethene, propene, 1-butene, i-butene, 1-pentene, cyclopentene, 1-hexene, cyclohexene, 1-octene and/or norbornene or one or more of these in admixture with 10-undecenoic acid, 3-butenoic acid, 4-pentenoic acid, 5-hexenoic acid and/or styrene-4-sulfonic acid.

The dispersants b) used in the process of the present invention can be emulsifiers or protective colloids.

Suitable protective colloids are, for example, polyvinyl alcohols, polyalkylene glycols, alkali metal salts of polyacrylic acids and polymethacrylic acids, gelatin derivatives or copolymers comprising acrylic acid, methacrylic acid, maleic anhydride, 2-acrylamido-2-methylpropanesulfonic acid and/or 4-styrenesulfonic acid and their alkali metal salts, and also N-vinylpyrrolidone, N-vinylcaprolactam, N-vinylcarbazole, 1-vinylimidazole, 2-vinylimidazole, 2-vinylpyridine, 4-vinylpyridine, acrylamide, methacrylamide, homopolymers and copolymers comprising acrylates, methacrylates, acrylamides and/or methacrylamides which bear amine groups. A comprehensive description of further suitable protective colloids may be found in Houben-Weyl, Methoden der organischen Chemie, Volume XIV/1, Makromolekulare Stoffe, Georg-Thieme-Verlag, Stuttgart, 1961, pp. 411 to 420.

Of course, it is also possible to use mixtures of protective colloids and/or emulsifiers. The dispersants used are frequently exclusively emulsifiers whose relative molecular weights are usually below 1000, unlike the protective colloids. They can be either anionic, cationic or nonionic in nature. Of course, when mixtures of surface-active substances are used, the individual components have to be compatible with one another, which can in case of doubt be checked with the aid of a few preliminary tests. In general, anionic emulsifiers are compatible with one another and with nonionic emulsifiers. An analogous situation applies to cationic emulsifiers, while anionic and cationic emulsifiers are usually not compatible with one another. An overview of suitable emulsifiers may be found in Houben-Weyl, Methoden der organischen Chemie, Volume XIV/1, Makromolekulare Stoffe, Georg-Thieme-Verlag, Stuttgart, 1961, pp. 192 to 208.

According to the present invention, dispersants b) used are, in particular, anionic, cationic and/or nonionic emulsifiers.

Nonionic emulsifiers which can be used are, for example, ethoxylated monoalkylphenols, dialkylphenols and trialkylphenols (EO content: 3-50, alkyl radical: C₄-C₁₂) and ethoxylated fatty alcohols (EO content: 3-80; alkyl radical: C₈-C₃₆). Examples are Lutensol® A grades (C₁₂C₁₄-fatty alcohol ethoxylates, EO content: 3-8), Lutensol® AO grades (C₁₃C₁₅-oxo alcohol ethoxylates, EO content: 3-30), Lutensol® AT grades (C₁₆CO₈-fatty alcohol ethoxylates, EO content: 11-80), Lutensol® ON grades (C₁₀-oxo alcohol ethoxylates, EO content: 3-11) and Lutensol® TO grades (C₁₃-oxo alcohol ethoxylates, EO content: 3-20) from BASF AG.

Customary anionic emulsifiers are, for example, alkali metal and ammonium salts of alkyl sulfates (alkyl radical: C₈-C₁₂), of sulfuric monoesters of ethoxylated alkanols (EO content: 4-30, alkyl radical: C₁₂-C₁₈) and ethoxylated alkylphenols (EO-content: 3-50, alkyl radical: C₄-C₁₂), of alkylsulfonic acids (alkyl radical: C₁₂-C₁₈) and of alkylarylsulfonic acids (alkyl radical: C₉-C₁₈).

Further useful anionic emulsifiers are compounds of the formula (X)

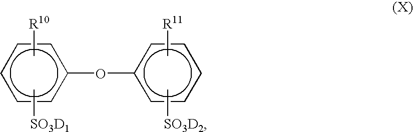

where R¹⁰ and R¹¹ are each an H atom or C₄-C₂₄-alkyl and are not both H atoms at the same time, and D¹ and D² are alkali metal ions and/or ammonium ions. In the formula (X), R¹⁰ and R¹¹ are preferably linear or branched alkyl radicals having from 6 to 18 carbon atoms, in particular 6, 12 and 16 carbon atoms, or hydrogen, with R¹⁰ and R¹¹ not both being H atoms at the same time. D¹ and D² are preferably sodium, potassium or ammonium, with sodium being particularly preferred. Particular advantageous compounds (X) are those in which D¹ and D² are each sodium, R¹⁰ is a branched alkyl radical having 12 carbon atoms and R¹¹ is an H atom or R¹⁰. Use is frequently made of industrial mixtures containing from 50 to 90% by weight of the monoalkylated product, for example Dowfax® 2A1 (trade name of Dow Chemical Company). The compounds (X) are generally known, e.g. from U.S. Pat. No. 4,269,749, and commercially available.

Suitable cationic emulsifiers are primary, secondary, tertiary or quaternary ammonium salts, alkanolammonium salts, pyridinium salts, imidazolinium salts, oxazolinium salts, morpholinium salts, thiazolinium salts and salts of amine oxides, quinolinium salts, isoquinolinium salts, tropylium salts, sulfonium salts and phosphonium salts each of which generally bear a C₆-C₁₈-alkyl, -alkylaryl or heterocyclic radical. Examples which may be mentioned are dodecylammonium acetate or the corresponding sulfate, the sulfates or acetates of the various 2-(N,N,N-trimethylammonium)ethylparaffinic esters, N-cetylpyridinium sulfate, N-laurylpyridinium sulfate and also N-cetyl-N,N,N-trimethylammonium sulfate, N-dodecyl-N,N,N-trimethylammonium sulfate, N-octyl-N,N,N-trimethylammonium sulfate, N,N-distearyl-N,N-dimethylammonium sulfate and also the gemini surfactant N,N′-(lauryldimethyl)ethylenediamine disulfate, ethoxylated tallow fatty alkyl-N-methylammonium sulfate and ethoxylated oleylamine (for example Uniperol® AC from BASF AG, about 12 ethylene oxide units). Numerous further examples may be found in H. Stache, Tensid-Taschenbuch, Carl-Hanser-Verlag, Munich, Vienna, 1981, and in McCutcheon's, Emulsifiers & Detergents, MC Publishing Company, Glen Rock, 1989. It is important that the anionic countergroups have a very low nucleophilicity, for example perchlorate, sulfate, phosphate, nitrate and carboxylates such as acetate, trifluoroacetate, trichloroacetate, propionate, oxalate, citrate, benzoate, and also conjugate anions of organosulfonic acids, for example methylsulfonate, trifluoromethylsulfonate and para-toluenesulfonate, also tetrafluoroborate, tetraphenylborate, tetrakis(pentafluorophenyl)borate, tetrakis[bis(3,5-trifluoromethyl)phenyl]borate, hexafluorophosphate, hexafluoroarsenate or hexafluoroantimonate.

The emulsifiers which are preferably used as dispersants b) are advantageously used in a total amount of from 0.005 to 10 parts by weight, preferably from 0.01 to 7 parts by weight, in particular from 0.1 to 5 parts by weight, in each case based on 100 parts by weight of the olefinically unsaturated compounds. The amount of emulsifier is frequently chosen so that the critical micelle formation concentration of the emulsifiers employed is not significantly exceeded in the aqueous phase.

The total amount of protective colloids used as dispersants b) in addition to or in place of the emulsifiers is often from 0.1 to 10 parts by weight and frequently from 0.2 to 7 parts by weight, in each case based on 100 parts by weight of the olefinically unsaturated compounds.

According to the invention, sparingly water-soluble organic solvents c) can also be used if desired. Suitable solvents c) are liquid aliphatic and aromatic hydrocarbons having from 5 to 30 carbon atoms, for example n-pentane and isomers, cyclopentane, n-hexane and isomers, cyclohexane, n-heptane and isomers, n-octane and isomers, n-nonane and isomers, n-decane and isomers, n-dodecane and isomers, n-tetradecane and isomers, n-hexadecane and isomers, n-octadecane and isomers, eicosane, benzene, toluene, ethylbenzene, cumene, o-, m- or p-xylene, mesitylene and also hydrocarbon mixtures in general which have boiling points in the range from 30 to 250° C. It is likewise possible to use hydroxy compounds such as saturated and unsaturated fatty alcohols having from 10 to 32 carbon atoms, for example n-dodecanol, n-tetradecanol, n-hexadecanol and their isomers or cetyl alcohol, ceryl alcohol or myricyl alcohol (mixture of C₃₀- and C₃₋₁-alcohols), esters such as fatty acid esters having from 10 to 32 carbon atoms in the acid moiety and from 1 to 10 carbon atoms in the alcohol moiety or esters of carboxylic acids and fatty alcohols having from 1 to 10 carbon atoms in the carboxylic acid moiety and from 10 to 32 carbon atoms in the alcohol moiety. Of course, it is also possible to use mixtures of the abovementioned solvents.

The total amount of solvent is up to 15 parts by weight, preferably from 0.001 to 10 parts by weight and particularly preferably from 0.01 to 5 parts by weight, in each case based on 100 parts by weight of water.

It is advantageous for the solvent c) or the solvent mixture to have a solubility in the aqueous reaction medium under reaction conditions of ≦50% by weight, ≦40% by weight, ≦30% by weight, ≦20% by weight or ≦10% by weight, in each case based on the total amount of solvent.

Solvents c) are used particularly when the olefinically unsaturated compounds are gaseous under reaction conditions (pressure/temperature), as is the case, for example, for ethene, propene, 1-butene and/or i-butene.

According to the present invention, it is essential for the total amount of metal complexes a1) including any acids a2) and organic hydroxy compounds a3) used to be dissolved in part of or the total amount of the olefinically unsaturated compounds and/or the sparingly water-soluble organic solvents c). The part or total amount of the olefinically unsaturated compounds and/or the sparingly water-soluble organic solvents c) in which the metal complexes a1) are dissolved is subsequently dispersed in an aqueous medium in the presence of dispersants b) to form a disperse phase having a mean droplet diameter of ≦1000 nm and, at reaction temperature, carbon monoxide and any remaining amounts of olefinically unsaturated compounds and/or sparingly water-soluble organic solvents c) are added continuously or discontinuously.

The process of the present invention is generally carried out by, in a first step, dissolving the total amount of metal complexes a1) and any acids a2) and organic hydroxy compounds a3) used in part of or the total amount of the olefinically unsaturated compounds and/or the sparingly water-soluble organic solvents c). This solution is subsequently dispersed together with the dispersants b) in the aqueous medium to form oil-in-water dispersions having a mean droplet diameter of >1000 nm, known as macroemulsions. These macroemulsions are then converted by known methods into oil-in-water emulsions having a mean droplet diameter of ≦1000 nm, known as miniemulsions, and these are admixed at reaction temperature with carbon monoxide and any remaining amounts of olefinically unsaturated compounds and/or sparingly water-soluble organic solvents c).

The mean size of the droplets of the disperse phase in the aqueous oil-in-water emulsions to be used according to the present invention can be determined using the principle of pseudoelastic dynamic light scattering (the z-average droplet diameter d_{z} of the unimodal analysis of the autocorrelation function). In the examples in the present text, a Coulter N4 Plus Particle Analyser from Coulter Scientific Instruments was used for this purpose (1 bar, 25° C.). The measurements were carried out on diluted aqueous miniemulsions whose content of nonaqueous constituents was 0.01% by weight. The dilution was carried out by means of water which had previously been saturated with the olefinically unsaturated compounds and/or sparingly water-soluble organic solvents c) present in the aqueous emulsion. The latter measure is to prevent a change in droplet diameter from occurring on dilution.

According to the present invention, the d_{z} values determined in this way for the miniemulsions are normally ≦700 nm, frequently ≦500 nm. The d_{z} range from 100 nm to 400 nm or from 100 nm to 300 nm is advantageous according to the present invention. d_{z} of the aqueous miniemulsion to be used according to the present invention is normally >40 nm.

The general preparation of aqueous miniemulsions from aqueous macroemulsions is known to those skilled in the art (cf. P. L. Tang, E. D. Sudol, C. A. Silebi and M. S. El-Aasser in Journal of Applied Polymer Science, Vol. 43, pp. 1059 to 1066 [1991]).

For this purpose, it is possible to employ, for example, high-pressure homogenizers. The fine dispersion of the components is achieved in these machines by means of a high local energy input. Two variants have been found to be particularly useful for the present purpose.

In the first variant, the aqueous macroemulsion is compressed to above 1000 bar by means of a piston pump and is subsequently depressurized through a narrow slit. The action here is based on interaction of high shear and pressure gradients and cavitation in the slit. An example of a high-pressure homogenizer which functions according to this principle is the Niro-Soavi high-pressure homogenizer model NS1001L Panda.

In the second variant, the compressed aqueous macroemulsion is depressurized into a mixing chamber via two nozzles pointing in opposite directions. Here, the finely dispersing action is dependent, in particular, on the hydrodynamic conditions in the mixing chamber. An example of this type of homogenizer is the Microfluidizer M 120 E from Microfluidics Corp. In this high-pressure homogenizer, the aqueous macroemulsion is compressed to pressures of up to 1200 atm by means of a pneumatically operated piston pump and depressurized in an “interaction chamber”. In the “interaction chamber”, the emulsion jet is divided in a microchannel system into two jets which are directed at one another at an angle of 180°. A further example of a homogenizer operating according to this homogenization principle is the Nanojet Expo from Nanojet Engineering GmbH. However, the Nanojet has two homogenizing valves which can be mechanically adjusted instead of a fixed channel system.

As an alternative to the above-described principles, the homogenization can also be carried out, for example, using ultrasound (e.g. Branson Sonifier II 450). The fine dispersion is here based on cavitation mechanisms. For homogenization by means of ultrasound, it is also possible in principle to use the apparatuses described in GB-A 22 50 930 and U.S. Pat. No. 5,108,654. The quality of the aqueous miniemulsion produced in the acoustic field depends not only on the acoustic power introduced but also on other factors such as the intensity distribution of the ultrasound in the mixing chamber, the residence time, the temperature and the physical properties of the materials to be emulsified, for example on the viscosity, the surface tension and the vapor pressure. The resulting droplet size depends, inter alia, on the concentration of the emulsifier and on the energy introduced during homogenization and can therefore be set in a targeted manner by, for example, appropriate operation of the homogenization pressure or the corresponding ultrasonic energy.

To produce the aqueous miniemulsion used according to the present invention from conventional macroemulsions by means of ultrasound, the apparatus described in the earlier German patent application DE 197 56 874 has been found to be particularly useful. This is an apparatus which has a reaction space or a flow-through reaction channel and at least one means of transmitting ultrasonic waves to the reaction space or the flow-through reaction channel, with the means of transmitting ultrasonic waves being configured so that the entire reaction space, or a section of the flow-through reaction channel, can be irradiated uniformly with ultrasonic waves. For this purpose, the radiative surface of the means of transmitting ultrasonic waves is configured so that it corresponds essentially to the surface of the reaction space or, if the reaction space is a section of a flow-through reaction channel, extends essentially across the entire width of the channel, and so that the depth of the reaction space essentially perpendicular to the radiative surface is less than the maximum depth of action of the means of transmitting ultrasound.

In the present context, the term “depth of the reaction space” is essentially the distance between the radiative surface of the means of transmitting ultrasound and the bottom of the reaction space.

Preference is given to reaction space depths up to 100 mm. The depth of the reaction space is advantageously not more than 70 mm and particularly advantageously not more than 50 mm. The reaction spaces can in principle also have a very small depth, but, with a view to a very low risk of blockage and ready cleanability and also a high product throughput, preference is given to reaction space depths which are significantly greater than, for example, the customary slit widths in high-pressure homogenizers and are usually greater than 10 mm. The depth of the reaction space is advantageously adjustable, for example by use of means of transmitting ultrasound which can reach down into the housing to various depths.

In a first embodiment of this apparatus, the radiative surface of the means of transmitting ultrasound corresponds essentially to the surface of the reaction space. This embodiment is employed for the batchwise production of the miniemulsions used according to the present invention. In this apparatus, ultrasound can act on the entire reaction space. Turbulent flow which effects intensive transverse mixing is generated in the reaction space as a result of the axial acoustic radiation pressure.

In a second embodiment, the apparatus has a flow-through cell. Here, the housing is configured as a flow-through reaction channel which has an inlet and an outlet and the reaction space is a section of the flow-through reaction channel. The width of the channel is the channel dimension essentially perpendicular to the flow direction. Here, the radiative surface covers the entire width of the flow channel perpendicular to the flow direction. The length of the radiative surface perpendicular to this width, i.e. the length of the radiative surface in the flow direction, defines the region over which the ultrasound acts. In an advantageous variant of this second embodiment, the flow-through reaction channel has an essentially rectangular cross section. If an appropriately dimensioned, likewise rectangular means of transmitting ultrasound is installed on one side of the rectangle, particularly effective and uniform acoustic irradiation is ensured. However, owing to the turbulent flow existing in the ultrasonic field, it is also possible to use, for example, a round transmission means without disadvantages. Furthermore, instead of a single means of transmitting ultrasound, it is possible to employ a plurality of separate transmission means which are arranged one after the other in the flow direction. In this case, both the radiative areas and the depth of the reaction space, i.e. the distance between the radiative surface and the bottom of the flow-through channel, can vary.

The means of transmitting ultrasonic waves is particularly advantageously configured as an ultrasonic probe whose end opposite the free radiative surface is coupled to an ultrasonic transducer. The ultrasonic waves can be generated, for example, by exploitation of the reverse piezoelectric effect. High-frequency electric oscillations (usually in the range from 10 to 100 kHz, preferably from 20 to 40 kHz) are produced by means of generators, transformed into mechanical vibrations at the same frequency by means of a piezoelectric transducer and transmitted into the medium to be treated with ultrasound using the ultrasonic probe as transmission element.

The ultrasonic probe is particularly preferably configured as a rod-shaped, axially radiating λ/2(or multiples of λ/2) longitudinal oscillator. Such an ultrasonic probe can, for example, be fixed in an opening in the housing by means of a flange provided at one of its vibration nodes. In this way, the ultrasonic probe can be passed through the housing in a pressure-tight manner, so that treatment with ultrasound can also be carried out under superatmospheric pressure in the reaction space. The amplitude of vibration of the ultrasonic probe is preferably able to be regulated, i.e. the vibration amplitude set in each case is checked on-line and automatically adjusted if necessary. The actual vibration amplitude can be checked, for example, by means of a piezoelectric transducer installed on the ultrasonic probe or a strain gauge with associated data processing electronics.

In a further advantageous embodiment of such an apparatus, the reaction space is provided with internals to improve the flow and mixing behavior. These internals can be, for example, simple deflection plates or a variety of porous bodies.

If necessary, mixing can also be intensified further by means of an additional agitator. The reaction space is advantageously heatable/coolable.

It is clear from the description given above that only those organic solvents c) or solvent mixtures whose solubility in the aqueous medium under the reaction conditions is small enough for the amounts indicated to form solvent droplets having a size of <1000 nm as a separate phase can be used according to the present invention. Furthermore, the solvent capability of the solvent droplets formed has to be sufficiently high for them to take up the metal complexes a1), the acids a2) and the organic hydroxy compounds a3). Analogous considerations also apply to the olefinically unsaturated compounds 1f these are used without organic solvent c), and to mixtures of olefinically unsaturated compounds and organic solvents c).

One embodiment of the process of the present invention provides, for example, for the total amounts of the metal complex a1) and any acids a2) and organic hydroxy compounds a3) added to be dissolved in part of or the total amount of the sparingly water-soluble organic solvents c). This organic metal complex solution is subsequently dispersed in water together with part of or the total amount of the dispersants b) to form a macroemulsion. This macroemulsion is converted into a miniemulsion by means of one of the abovementioned homogenization apparatuses. Carbon monoxide, the total amount of the olefinically unsaturated compounds and any remaining amounts of organic solvents c) or dispersants b) are metered into this at reaction temperature and while stirring continually. This process variant is selected particularly when the olefinically unsaturated compounds used are gaseous under the reaction conditions, as is the case, for example, for ethene, propene, 1-butene and/or i-butene.

In a further embodiment, the total amount of metal complex a1) and any acids a2) and organic hydroxy compounds a3) added is dissolved in part of or the total amount of the olefinically unsaturated compounds. This organic metal complex solution is subsequently dispersed in water together with part of or the total amount of the dispersants b) to form a macroemulsion. The macroemulsion is converted into a miniemulsion by means of one of the abovementioned homogenization apparatuses. Carbon monoxide, any remaining amounts of olefinically unsaturated compounds or dispersants b) and the total amount of any sparingly water-soluble organic solvents c) to be used are metered into these miniemulsions at reaction temperature and while stirring continually. This process variant is selected particularly when the olefinically unsaturated compounds used are liquid under the reaction conditions, as is the case, for example, for 1-pentene, cyclopentene, 1-hexene, cyclohexene, 1-octene, 1-decene, 1-dodecene, 1-tetradecene and/or 1-hexadecene.

In the process of the present invention, it is essential that the metal complexes a1) are in solution in at least part of the olefinically unsaturated compounds and/or the sparingly water-soluble organic solvents c) and that this solution is present as a separate phase having a mean droplet size of ≦1000 nm in the aqueous medium under the reaction conditions. Any remaining amounts of the olefinically unsaturated compounds and/or the sparingly water-soluble organic solvent c) can be added as such, in solution or together with any remaining amount of dispersant b), optionally in the form of an aqueous macroemulsion, to the aqueous reaction medium. If solvents c) are used, the total amount of the solvents is usually used for dissolving the metal complexes a1) and is subsequently dispersed in the aqueous medium.

It should be noted that the liquid droplets having a size of ≦1000 nm which are present as a separate phase in the aqueous medium can further comprise other components in addition to the abovementioned compounds a1), a2), a3) and c) and the olefinically unsaturated compounds. Such further components are, for example, 1,4-quinone compounds which have a positive effect on the activity of the metal complexes a1) and their operating life. Apart from unsubstituted or alkyl-substituted 1,4-benzoquinone, it is also possible to use further 1,4-quinone compounds, for example unsubstituted or alkyl-substituted 1,4-naphthoquinone. The molar ratio of any 1,4-quinone compounds used to metal complex a1), based on the amount of metal M, is generally up to 1000, often from 5 to 500 and frequently from 7 to 250. Further components which are possible are, for example, formulation aids, antioxidants, light stabilizers, and also dyes, pigments and/or waxes for hydrophobicization. If the solubility of the further components in the organic phase forming the droplets is greater than in the aqueous medium, they remain in the droplets during the copolymerization. Since the droplets of olefinically unsaturated compounds and/or sparingly water-soluble solvents c) in which the metal complexes a1) are present represent, in the final analysis, the site of copolymerization of carbon monoxide and the olefinically unsaturated compounds, these additional components are generally present in the copolymer particles formed.

The molar ratio of carbon monoxide to the olefinically unsaturated compounds is generally in the range from 10:1 to 1:10, usually from 5:1 to 1:5 or from 2:1 to 1:2.

The copolymerization temperature is generally set in a range from 0 to 200° C. preferably from 20 to 130° C. and in particular from 40 to 100° C. The carbon monoxide partial pressure is generally in the range from 1 to 300 bar, in particular from 10 to 220 bar. It is advantageous for the total partial pressure of the olefinically unsaturated compounds under the reaction conditions to be lower than the carbon monoxide partial pressure. In particular, the total partial pressure of the olefinically unsaturated compounds under the reaction conditions is ≦50%, ≦40%, ≦30% or even ≦20% of the total pressure. The polymerization reactor is usually made inert by flushing with carbon monoxide, olefinically unsaturated compounds or inert gas, for example nitrogen or argon, before it is pressurized with carbon monoxide. However, the polymerization is frequently also possible without the reactor being made inert beforehand.

In the polymerization process of the present invention, the mean catalyst activities obtained are generally ≧0.17 kg, frequently ≧0.25 kg and often ≧0.5 kg, of copolymer per gram of complex metal and hour.

The process of the present invention gives aqueous copolymer dispersions whose number average copolymer particle diameter determined by pseudoelastic light scattering (ISO standard 13321) is up to 1000 nm, frequently from 100 to 800 nm and often from 200 to 400 nm. It is worth noting that the copolymer particles generally have a narrow, monomodal particle size distribution.

The weight average molecular weights of the copolymers obtainable according to the present invention, as determined by gel permeation chromatography using polymethyl methacrylate as standard, are generally in the range from 1000 to 1000000, frequently in the range from 1500 to 800000 and often in the range from 2000 to 600000.

The copolymers obtainable by the process of the present invention are, as evidenced by ¹³C— or ¹H-NMR spectroscopy, generally linear, alternating carbon monoxide copolymer compounds. For the purposes of the present invention, this term refers to copolymer compounds in which each carbon monoxide unit is followed in the polymer chain by a —CH₂—CH₂—, —CH₂—CH— or —CH—CH— unit-derived from the olefinic double bond of the olefinically unsaturated compound(s) and each —CH₂—CH₂—, —CH₂—CH— or —CH—CH-unit is followed by a carbon monoxide unit. In particular, the ratio of carbon monoxide units to —CH₂—CH₂—, —CH₂—CH— or —CH—CH-units is generally from 0.9:1 to 10.9, frequently from 0.95:1 to 1:0.95 and often from 0.98:1 to 1:0.98.

According to the present invention, targeted variation of the olefinically unsaturated compounds makes it possible to prepare copolymers whose glass transition temperature or melting point is in the range from −60 to 270° C.

For the present purposes, the glass transition temperature T_{g} is the limiting value to which the glass transition temperature tends with increasing molecular weight, as described by G. Kanig (Kolloid-Zeitschrift & Zeitschrift für Polymere, vol. 190, p. 1, equation 1). The glass transition temperature is determined by the DSC method (differential scanning calorimetry, 20 K/min, midpoint measurement, DIN 53765).

According to Fox (T. G. Fox, Bull. Am. Phys. Soc. 1956 [Ser. II] 1, p. 123, and as described in Ullmann's Encyclopädie der technischen Chemie, vol. 19, p. 18, 4^{th} edition, Verlag Chemie, Weinheim, 1980), the glass transition temperature of at most slightly crosslinked copolymers is given to a good approximation by:

1/T_{g}x¹/T_{g}¹+x²/T_{g}²+ . . . xⁿ/T_{g}ⁿ,

where x¹, x², . . . xⁿ are the mass fractions of the monomers 1, 2, . . . n and T_{g}¹, T_{g}², . . . T_{g}ⁿ are the glass transition temperatures in degrees kelvin of the respective polymers made up of only one of the monomers 1, 2 . . . n. The T_{g} values for the homopolymers of most monomers are known and reported, for example, in Ullmann's Encyclopedia of Industrial Chemistry, vol. 5, section A21, p. 169, VCH Weinheim, 1992; further sources of glass transition temperatures of homopolymers are, for example, J. Brandrup, E. H. Immergut, Polymer Handbook, 1^{st} Ed., J. Wiley, New York 1966, 2^{nd} Ed. J. Wiley, New York 1975, and 3rd Ed. J. Wiley, New York 1989).

The copolymer dispersions of the present invention frequently have minimum film formation temperatures MFT of ≦80° C., often ≦50° C. or ≦30° C. Since the MFT is no longer measurable below 0° C., the lower limit of the MFT can only be indicated by the T_{g} values. The MFT is determined in accordance with DIN 53787.

The process of the present invention makes it possible to obtain aqueous copolymer dispersions having a solids content in the range from 0.1 to 70% by weight, frequently from 1 to 65% by weight and often from 5 to 60% by weight.

Of course, the residual monomers remaining in the aqueous copolymer system after conclusion of the main polymerization reaction can be removed by stripping with steam and/or inert gas without the polymer properties of the copolymers present in the aqueous medium being adversely affected.

The aqueous copolymer dispersions obtainable according to the present invention are frequently stable for weeks or months and during this time generally display virtually no phase separation, precipitation phenomena or coagulum formation. They are very suitable as, for example, binders in the production of adhesives, for example pressure sensitive adhesives, building adhesives or industrial adhesives, sealing compositions, polymer-based plasters and renders and surface coatings, for example for paper coating, emulsion paints or for printing inks and printing varnishes for printing polymer films, and for producing nonwovens or for producing protective layers and water barriers, for example in priming. These aqueous copolymer dispersions can likewise be used for modifying mineral binders or other polymers.

It may also be stated that the aqueous copolymer dispersions obtainable according to the present invention can be dried in a simple manner to give redispersible copolymer powders (e.g. by freeze drying or spray drying). This is particularly the case when the glass transition temperature of the copolymers is ≧50° C., preferably ≧60° C., particularly preferably ≧70° C., very particularly preferably ≧80° C. and most preferably ≧90° C. or ≧100° C. The copolymer powders are likewise suitable as binders in adhesives, sealing compositions, polymer-based plasters and renders and surface coatings, and for producing nonwovens or for modifying mineral binders, for example mortar or cement, or as modifying additives to other polymers.

The process of the present invention provides an economical, environmentally friendly, preparatively simple and essentially safe route to aqueous copolymer dispersions of linear, alternating carbon monoxide copolymers using the readily available oil-soluble metal complexes customary in the suspension polymerization of carbon monoxide and olefinically unsaturated compounds. Owing to the way in which they are prepared, the aqueous copolymer dispersions obtainable according to the present invention comprise copolymer particles which contain only very small amounts [possibly, for example, organic hydroxy compound a3)], if any, of organic solvents. However, if the process of the present invention is carried out in the presence of sparingly water-soluble solvents c), unpleasant odors in the formation of copolymer films can be avoided by choice of the high-boiling solvents c). On the other hand, the solvents c) which are optionally used frequently act as coalescing agents and thus promote film formation. Due to the method of preparation, the copolymer dispersions obtainable according to the present invention comprise copolymer particles having a narrow, monomodal particle size distribution. The aqueous copolymer dispersions obtained are also stable for weeks and months in the presence of small amounts of dispersants and during this time generally display virtually no phase separation, precipitation phenomena or coagulum formation. However, the process of the present invention also makes it possible to obtain aqueous copolymer dispersions whose copolymer particles further comprise additional additives such as formulation aids, antioxidants, light stabilizers, and also dyes, pigments and/or waxes in addition to the copolymer. A further advantage of the process of the present invention is that the additives used, for example the stabilizers used, are initially present in the particle, which makes mixing very good.

This also makes it possible to reduce the number of formulation steps.

The present invention is illustrated by the following examples.

1. Preparation of Metal Complexes

[1,3-Bis(diphenylphosphino)propane]palladium(II) acetate

50 ml of anhydrous tetrahydrofuran (THF) were placed under an argon atmosphere in a 100 ml Schlenk tube at 20-25° C. (room temperature), and 5.0 g of palladium(II) acetate (98%, from Aldrich) were added while stirring by means of a magnetic stirrer. After 5 minutes, the resulting brown solution was filtered through a glass frit, a solution of 9.9 g of 1,3-bis(diphenylphosphino)propane (98%; from Strem Chemicals GmbH) in 20 ml of anhydrous THF was added to the clear filtrate while stirring under an argon atmosphere and the resulting yellow solution was stirred for 20 minutes at room temperature. The solvent was subsequently distilled off under reduced pressure, leaving 14.9 g (99% of theory) of a yellow solid (complex 1).

[1,3-Bis(di(n-decyl)phosphino)propane]palladium(II) acetate

The preparation of [1,3-bis(di(n-decyl)phosphino)propane]-palladium(II) acetate was carried out by a method analogous to that for complex 1, but using 16 g of 1,3-bis(di(n-decyl)phosphino)propane instead of 1,3-bis(diphenylphosphino)propane. Distilling off the solvent left 21 g (99% of theory) of a reddish brown solid (complex 2). The preparation of 1,3-bis(di (n-decyl)phosphino)propane was carried out as described by Lindner et al. in J. Organomet. Chem. 2000 (602), pp. 173 to 187.

### 2. POLYMERIZATION EXAMPLES

### Example 1

In a Schlenk tube, 10 mg of complex 1 were dissolved in 5 g of toluene (99% by weight; from Aldrich) at room temperature under an argon atmosphere while stirring, subsequently admixed with 15 mg of trifluoroacetic acid (99% by weight; from Aldrich), 0.5 g of n-hexadecane (99% by weight, from Aldrich), 10 mg of 1,4-benzoquinone (98% by weight; from Aldrich) and 1 g of 10-undecenoic acid (98% by weight; from Aldrich) and the mixture was stirred for 5 minutes. The organic solution of the complex obtained in this way was stirred at room temperature and under an argon atmosphere into an aqueous solution consisting of 100 g of deionized water and 1.0 g of Texapon® NSO (sodium salt of a sulfuric monoester of n-dodecanol ethoxylate, mean degree of ethoxylation: 25; trade name of Henkel) to form an oil-in-water emulsion. This emulsion was brought into contact with an ultrasonic probe (Sonifier II 450 from Branson) for 10 minutes and the mean droplet size was subsequently determined.

The mean droplet size of the aqueous emulsions was generally determined by means of pseudoelastic dynamic light scattering using a Coulter N4 Plus Particle Analyser from Coulter Scientific Instruments. In the present case, the mean droplet size was 200 nm.

The aqueous emulsion obtained was then transferred to a 300 ml steel autoclave equipped with a bar stirrer and the air was displaced by flushing a number of times with ethylene. The autoclave was subsequently pressurized at room temperature with 30 bar of ethylene and 30 bar of carbon monoxide. The reaction mixture was heated to 80° C. while stirring (500 revolutions per minute) and was stirred at this temperature for 2 hours. The reaction mixture was then cooled to room temperature and the contents of the steel autoclave were depressurized to atmospheric pressure. 100 g of an aqueous copolymer dispersion having a solids content of 10% by weight and a coagulum content of <1% by weight were obtained. The mean particle size was 350 nm. The melting point was found to be 260° C. Furthermore, the aqueous copolymer dispersion was stable and displayed no phase separation, precipitation phenomena or coagulum formation over a period of 10 weeks.

The solids content was generally determined by drying about 1 g of the aqueous copolymer dispersion to constant weight in an open aluminum crucible having an internal diameter of about 3 cm in a drying oven at 100° C. and 10 mbar (absolute). To determine the solids content, two separate measurements were carried out in each case and the corresponding mean was calculated.

The coagulum content was generally determined by filtering the entire aqueous copolymer dispersion obtained through a 45 μm filter cloth. The filter cloth was subsequently rinsed with 50 ml of deionized water and dried to constant weight at 100° C./1 bar (absolute). The coagulum content was determined from the weight difference of the filter cloth prior to filtration and the filter cloth after filtration and drying.

The mean particle diameter of the copolymer particles was generally determined on an aqueous dispersion having a concentration of from 0.005 to 0.01 percent by weight by dynamic light scattering at 23° C. using an Autosizer IIC from Malvern Instruments, United Kingdom. The figure reported is the mean diameter of the cumulative distribution (cumulant z average) of the measured autocorrelation function (ISO standard 13321).

The determination of the glass transition temperature or the melting point was generally carried out in accordance with DIN 53765 by means of a DSC820 instrument, series TA8000, from Mettler-Toledo.

### Comparative Example

The procedure of Example 1 was repeated, except that 2 g of methanol instead of 5 g of toluene were used for dissolving the complex 1 and no n-hexadecane was added to the organic solution of the complex. It is significant that when stirred into the aqueous reaction medium, the organic solution of the complex dissolved without formation of a visible heterogeneous phase.

After depressurization of the steel autoclave to atmospheric pressure, a clear aqueous solution which contained no copolymer was obtained.

### Example 2

In a Schlenk tube, 10 mg of complex 2 were dissolved in 10 g of n-octadecane (99% by weight; from Aldrich) at 50° C. under an argon atmosphere while stirring, subsequently admixed with 15 mg of trifluoroacetic acid and the mixture was stirred for 5 minutes. The organic solution of the complex obtained in this way was stirred at 50° C. and under an argon atmosphere into an aqueous solution consisting of 100 g of deionized water and 1.0 g of Texapon® NSO to form an oil-in-water emulsion. This emulsion was brought into contact with an ultrasonic probe (Sonifier II 450 from Branson) for 10 minutes and the mean droplet size was subsequently found to be 200 nm.

The aqueous emulsion obtained was cooled to room temperature and then transferred to a 300 ml steel autoclave equipped with a bar stirrer and the air was displaced by flushing a number of times with 1-butene. At room temperature, 30 g of 1-butene were subsequently introduced and the autoclave was pressurized with 60 bar of carbon monoxide. The reaction mixture was heated to 80° C. while stirring (500 revolutions per minute) and was stirred at this temperature for 10 hours. The reaction mixture was then cooled to room temperature and the contents of the steel autoclave were depressurized to atmospheric pressure. 120 g of an aqueous copolymer dispersion having a solids content of 20% by weight and a coagulum content of <0.1% by weight were obtained. The mean particle size was 230 nm. The glass transition temperature was found to be −10° C. Furthermore, the aqueous copolymer dispersion was stable and displayed no phase separation, precipitation phenomena or coagulum formation over a period of 10 weeks.

### Example 3

In a Schlenk tube, 50 mg of complex 2 were dissolved in 300 g of 1-octadecane (90% by weight; from Aldrich) at room temperature under an argon atmosphere while stirring, subsequently admixed with 75 mg of trifluoroacetic acid and the mixture was stirred for 5 minutes. The organic solution of the complex obtained in this way was stirred at room temperature and under an argon atmosphere into an aqueous solution consisting of 700 g of deionized water and 10 g of Lumiten® IRA (di-2-ethylhexyl sulfosuccinate; trade name of BASF AG) to form an oil-in-water emulsion. This emulsion was emulsified by means of a microfluidizer (model M 120 from Microfluidics Corp.) in a single pass at 1000 bar and the mean droplet size was subsequently found to be 220 nm.

The aqueous emulsion obtained was then transferred to a 3.5 l steel autoclave equipped with a bar stirrer and the air was displaced by flushing a number of times with carbon monoxide. The autoclave was subsequently pressurized at room temperature with 60 bar of carbon monoxide. The reaction mixture was heated to 80° C. while stirring (500 revolutions per minute) and was stirred at this temperature for 15 hours. The reaction mixture was then cooled to room temperature and the contents of the steel autoclave were depressurized to atmospheric pressure. After separating off unreacted 1-octadecene by means of a separating funnel, 950 g of an aqueous copolymer dispersion having a solids content of 18% by weight and a coagulum content of <0.1% by weight were obtained. The mean particle size was 300 nm. The melting point was found to be 40° C. Furthermore, the aqueous copolymer dispersion was stable and displayed no phase separation, precipitation phenomena or coagulum formation over a period of 10 weeks.

### Example 4

At room temperature, 10 mg of palladium(II) acetate were dissolved in 1 g of methanol under an argon atmosphere with stirring, subsequently added under an argon atmosphere in a Schlenk tube to a solution consisting of 34-mg of 2,2′-bypyridine (99% by weight, from Aldrich), 41 mg of trifluoroacetic acid, 4.0 g of 10-undecenoic acid, 2.0 g of n-hexadecane, 20 mg of 1,4-benzoquinone and 200 g of styrene (99% by weight, from BASF) while stirring and the mixture was stirred for 10 minutes. The organic solution of the complex obtained in this way was stirred at room temperature and under an argon atmosphere into an aqueous solution consisting of 600 g of deionized water and 8 g of emulsifier K30 (sodium salt of C₁₀-C₁₈-alkylsulfonic acid; from Bayer A G) to form an oil-in-water emulsion. This emulsion was emulsified by means of a high-pressure homogenizer (model NS 1001 L Panda from Niro Soavi) in a single pass at 850 bar and the mean droplet size was subsequently found to be 180 nm.

The aqueous emulsion obtained was then transferred to a 3.5 l steel autoclave equipped with a bar stirrer and the air was displaced by flushing a number of times with carbon monoxide. The autoclave was subsequently pressurized at room temperature with 60 bar of carbon monoxide. The reaction mixture was heated to 80° C. while stirring (500 revolutions per minute) and was stirred at this temperature for 16 hours. The reaction mixture was then cooled to room temperature and the contents of the steel autoclave were depressurized to atmospheric pressure. After separating off unreacted styrene by means of a separating funnel, 700 g of an aqueous copolymer dispersion having a solids content of 15% by weight and a coagulum content of <0.1% by weight were obtained. The mean particle size was 300 nm. The melting point was found to be 40° C. Furthermore, the aqueous copolymer dispersion was stable and displayed no phase separation, precipitation phenomena or coagulum formation over a period of 10 weeks.

We claim:

1. A process for preparing aqueous dispersions of copolymers of carbon monoxide and olefinically unsaturated compounds by copolymerizing carbon monoxide and olefinically unsaturated compounds in an aqueous medium in the presence of
a1) metal complexes of the formula (I) 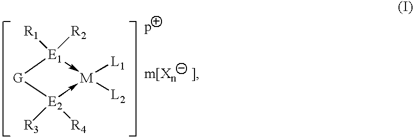
where the substituents and indices have the following meanings:
G is —(CR^{b}₂)ᵣ— or —(CR^{b}₂)ₛ—Si(R^{a})₂—(CR^{b}₂)ₜ—, -A-O—B— or -A-Z(R⁵)—B— where
R⁵ is hydrogen, linear or branched C₁-C₂₀-alkyl, C₃-C₁₀-cycloalkyl, C₆-C₁₄-aryl, C₆-C₁₄-aryl bearing functional groups based on nonmetallic elements of the groups IVA, VA, VIA and VIIA of the Periodic Table as substituents, aralkyl having from 1 to 20 carbon atoms in the alkyl part and from 6 to 14 carbon atoms in the aryl part, heteroaryl, long-chain radicals which have from 5 to 30 carbon atoms in the chain and have polar or charged end groups, —N(R^{b})₂, —Si(R^{c})₃ or a radical of the formula II 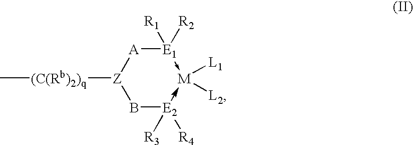
where
q is an integer from 0 to 20 and the further substituents in formula (II) are as defined for formula (I)
A, B are each —(CR^{b}₂)_{r′}— or —(CR^{b}₂)ₙ—Si(R^{a})₂—(CR^{b}₂)ₜ— or —N(R^{b})—, an r′-, s- or t-atomic constituent of a ring system or together with Z an (r′+1)-, (s+1)- or (t+1)-atomic constituent of a heterocycle,
R^{a} are each, independently of one another, linear or branched C₁-C₂₀-alkyl, C₃-C₁₀-cycloalkyl, C₆-C₁₄-aryl, C₆-C₁₄-aryl bearing functional groups based on nonmetallic elements of groups IVA, VA, VIA and VIIA of the Periodic Table as substituents, aralkyl having from 1 to 20 carbon atoms in the alkyl part and from 6 to 14 carbon atoms in the aryl part,
R^{b} may be as defined for R^{a} and may also be hydrogen or —Si(R^{c})₃,
R^{c} is linear or branched C₁-C₂₀-alkyl, C₃-C₁₀-cycloalkyl, C₆-C₁₄-aryl or aralkyl having from 1 to 20 carbon atoms in the alkyl part and from 6 to 14 carbon atoms in the aryl part,
r is 1, 2, 3 or 4 and
r′ is 1 or 2,
s, t are each 0, 1 or 2, where 1<s+t<3
Z is an element of group VA of the Periodic Table of the Elements,
M is a metal selected from groups VIIIB, IB and IIB of the Periodic Table of the Elements,
E¹, E² are each a nonmetallic element of group VA of the Periodic Table of the Elements,
R¹ to R⁴ are each, independently of one another, linear or branched C₁-C₂₀-alkyl, C₃-C₁₀-cycloalkyl, C₆-C₁₄-aryl, C₆-C₁₄-aryl bearing functional groups based on nonmetallic elements of groups IVA, VA, VIA and VIIA of the Periodic Table as substituents, aralkyl having from 1 to 20 carbon atoms in the alkyl part and from 6 to 14 carbon atoms in the aryl part or heteroaryl,
L¹, L² are formally charged or uncharged ligands,
X are formally monovalent or polyvalent anions,
p is 0, 1, 2, 3 or 4,
m, n are each 0, 1, 2, 3 or 4,
where p=m×n,
or a compound of the formula (III) 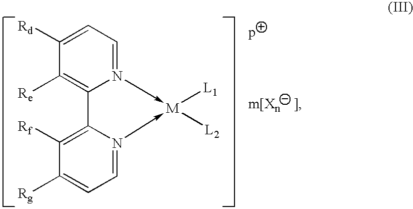
where
R^{d}, R^{e},
R^{f}, R^{g} are each, independently of one another, hydrogen, linear or branched C₁-C₆-alkyl or
R^{e} and R^{f} together form a five- or six-membered carbocycle or heterocycle and
the other substituents and indices are as defined under formula (I),
b) dispersants and, if desired,
c) sparingly water-soluble organic solvents, where
d) the metal complexes a1) are present in solution in part of or the total amount of the olefinically unsaturated compounds and/or the sparingly water-soluble organic solvents c) and
e) the part or total amount of the olefinically unsaturated compounds and/or the sparingly water-soluble organic solvent c) in which the metal complexes a1) are dissolved is present in the aqueous medium as a disperse phase having a mean droplet diameter of ≦1000 nm.

2. A process as claimed in claim 1, wherein the copolymerization is carried out in the presence of
a1) metal complexes of the formula (I) or (III) and
a2) an acid.

3. A process as claimed in claim 1 or 2, wherein the copolymerization is carried out in the presence of
a1) metal complexes of the formula (I) or (III),
a2) an acid and
a3) an organic hydroxy compound.

4. A process as claimed in any of claims 1 to 3, wherein olefinically unsaturated compounds used are ethene, propene, 1-butene, i-butene, 1-pentene, cyclopentene, 1-hexene, 1-octene, cyclohexene and/or norbornene or these in admixture with 10-undecenoic acid, 3-butenoic acid, 4-pentenoic acid, 5-hexenoic acid and/or styrene-4-sulfonic acid.

5. A process as claimed in any of claims 1 to 4, wherein dispersants b) used are anionic, cationic and/or nonionic emulsifiers.

6. A process as claimed in any of claims 1 to 5, wherein organic solvents c) used are aliphatic and aromatic hydrocarbons and also fatty alcohols and fatty acid esters.

7. A process as claimed in any of claims 1 to 6, wherein the part or total amount of the olefinically unsaturated compounds and/or the sparingly water-soluble organic solvent c) in which the metal complexes a1) are dissolved and which is present in the aqueous medium as a disperse phase having a mean droplet diameter of <1000 nm further comprises additional components.

8. An aqueous copolymer dispersion prepared by a process as claimed in any of claims 1 to 6.

9. The use of an aqueous copolymer dispersion as claimed in claim 7 as binder in adhesives, sealing compositions, polymer-based plasters and renders and surface coatings.
